(19) United States
(12) Patent Application Publication
(10) Pub. No.: US 2012/0181264 A1
(43) Pub. Date: Jul. 19, 2012

(54) METHOD OF CUTTING A SUBSTRATE AND A DEVICE FOR CUTTING

(75) Inventors: Enrico Stura, Grandvaux (CH); Christian Schmidt, Obwalden (CH); Michael Linder, Neuchatel (CH)

(73) Assignee: picoDrill SA, Lausanne (CH)

(21) Appl. No.: 13/498,349

(22) PCT Filed: Sep. 29, 2010
(86) PCT No.: PCT/EP2010/005945

§ 371 Date: Mar. 27, 2012

Related U.S. Application Data
(60) Provisional application No. 61/246,684, filed on Sep. 29, 2009.

(51) Int. Cl. H05B 7/18

(52) U.S. Cl. 219/384

(57) ABSTRACT

The present invention relates to a method of cutting a substrate by the introduction of thermo-mechanical tensions. The present invention also relates to the precise manufacturing of a substrate shape by the cutting method specified. The present invention also relates to a device for performing the method according to the present invention.

The present invention relates to a method of cutting a substrate by the introduction of thermo-mechanical tensions. The present invention also relates to the precise manufacturing of a substrate shape by the cutting method specified. The present invention also relates to a device for performing the method according to the present invention.

Precise and controlled cutting of materials subject to plastic fracture such as glass is required for many industrial processes and goods.

Traditional cutting methods typically require the removal of some material for separation, e.g. sawing or traditional laser cutting, leading to contamination of adjacent substrate surfaces and edges that are not clean cuts, i.e. departing from an ideal cut surface by showing secondary structures. Some of these standard cutting processes involve mechanical grinding operations, e.g. cutting by diamond-coated wheels or drills, currently used in large scale glass manufacturing. Such techniques compromise the regularity/quality of the obtained edges and release debris particles that negatively affect the substrate surfaces, often requiring additional cleaning or polishing steps. Many of these standard cutting processes can also induce micro cracks along the cut that may become starting points for macroscopic fractures and substrate destruction when mechanical stress is applied.

More recent cutting approaches use laser beams to heat along a path on the substrate that is subsequently followed by a cooling system using a liquid or gaseous medium or mixture thereof to induce a defined fracture. However, these techniques have drawbacks: high cost of the required equipment, necessity to protect personnel both from direct and from reflected laser exposure, different optical response to laser beam wavelength for different materials such as different glass types. Moreover, laser cutting is only suitable for a limited range of material thickness, too thin or too thick substrates are currently mostly processed using standard techniques.

Accordingly, it was an object of the present invention to provide for a method to cut a material without removing parts of the substrate; it was furthermore an objective to process effectively thin and thick substrates and to enable the cutting of straight and randomly shaped cuts of the substrate. It was also an object to avoid the deposition of any debris material released during the cutting process. Furthermore, it was an objective to obtain clean and flat surfaces in the cut region and to prevent the formation of micro fractures along the cut border. It was also an object of the present invention to provide for a method of cutting a material which method is inexpensive. It was also an objective of the present invention to provide for a method, which is easy to perform and allows to obtain regular cuts in materials of different thicknesses.

All these objects are solved by a method of cutting a substrate, said method comprising the steps:
a) providing a substrate to be cut,
b) applying, by means of one or more electrode(s) connected to an AC voltage source, electrical and thermal energy to said substrate by applying, at a frequency in the range of from 1 kHz to 10 GHz, an AC voltage and an electrical current to a defined region of said substrate, thereby heating said defined region,
c) cooling said defined region,
d) wherein, during step b), said defined region is moved along a path on the substrate surface by moving
   i) said electrode(s) relative to said substrate,
   ii) said substrate relative to said electrode(s), or
   iii) both said electrode(s) and said substrate relative to each other,
and wherein said path is not along an edge of said substrate, but is transversing said substrate either fully or partially.

In one embodiment, the substrate serves as a counterelectrode to establish a closed electrical circuit.

In one embodiment, a counterelectrode is placed on the opposite side of the substrate to be cut, to establish a closed electrical circuit.

In one embodiment, the counterelectrode is grounded.

In one embodiment, step b) manifests itself in electrical arc formation between said electrode(s) and said defined region, wherein, preferably, said electrical arc(s) is (are) used for cutting the substrate.

Typically, the current needs a closed loop to flow. The term “electrical circuit” as used herein is meant to refer to an electrical network that has a closed loop giving a return path for the current that flows. In such embodiments, the substrate acts as a part of this loop. So the current leaving the AC (high voltage high frequency) power supply flows through the electrode, the arc formed between electrode and substrate and the substrate itself back to the power supply. In such embodiments, the substrate is thereby acting as a counter-electrode and return path. The setup may be further simplified by referencing the ac power supply to ground. This allows to omit a dedicated conductive path (e.g. wires etc) leading from the substrate back to the power supply. The substrate may therefore be placed just on any part related to ground.

In particular for thick materials, using only one electrode may sometimes lead to an asymmetric and non-homogeneous heating inside the substrate that makes cutting more difficult with increasing thickness. To ensure the current flows equally through the entire thickness of the substrate, in some embodiments, a counterelectrode is used that provides a dedicated return path to ground. The current flowing back to the power supply via the substrate is strongly reduced that way. Without wishing to be bound by any theory, two positive effects for the cutting are promoted that way: (1) an electric arc can form on both sides of the substrate, enabling heating of the substrate by external heat from both sides and (2) the electric field inside the substrate is increased as it may approach up to E=(applied voltage) divided by (substrate thickness). This further increases internal heating by dielectric losses.

The alignment of the electrodes allows furthermore to control to some extent the path of the current and heating, respectively, through the substrate.

In one embodiment, the heating of the substrate is controlled by adjusting frequency and/or amplitude of said AC voltage and/or electrical current and/or distance of the electrode(s) to the substrate.

Without wishing to be bound by any theory, the power dissipated inside the substrate by dielectric loss phenomena is

pᵢₙ=∈ᵣ∈₀ tan δωE²

This defines user controllable parameters for cutting: (1) raising the frequency ω increases the heating, allowing a faster heating and therefore possibly faster cutting or cutting of thicker materials. It also provides the means to compensate for dielectric parameters not favorable to cutting, such as eg low dielectric loss tangent and low ∈ᵣ. (2) raising the voltage amplitude increases as well the dielectric loss and accordingly cutting behavior.

Because also heating from the outside by the electric arc may play a role for cutting, modifying its strength influences the cutting. The electric arc depends on the applied voltage, the current flowing, the frequency, the distance of the electrode to the substrate. Depending on the substrate material, these parameters may be varied to define optimal cutting conditions.

In one embodiment, for performing step b), said electrode(s) is (are) placed at a distance of from 0 mm to 100 mm to said substrate, on one or both side(s) of said substrate.

The heat distribution inside the substrate may be controlled by using different electrode distances to the substrate. As the electric arc depends on the electrode distance, heating of the substrate by the electric arc will be different on both sides, which is then reflected by the vertical temperature distribution inside the substrate.

In one embodiment, step b) is performed by applying a voltage having an amplitude in the range of from 10 V to 10⁷ V, preferably form 100 V to 10⁶ V, more preferably from 100 V to 10⁵V and a frequency in the range of from 1 kHz to 10 GHz, preferably from 10 kHz to 1 GHz, more preferably from 100 kHz to 100 MHz.

In one embodiment, the properties of the electrical arc are controlled by changing the atmosphere surrounding the electrode(s) and the substrate, for example using nitrogen, argon or sulfur hexafluoride at a pressure in the range of 10⁻⁵ to 10³ bar, preferably of 10⁻³ to 10 bar.

Modifying composition and pressure of the surrounding atmosphere allows to control the shape and temperature of the electric arc as well as the shape and size of the area touched by the electric arc.

In one embodiment, in step c), said defined region is cooled according to any of the following methods:
i) passively through heat conduction and/or convection with the surrounding environment
ii) attaching the substrate to an element able to absorb heat efficiently, optionally working as active heat pump, for example a Peltier element,
iii) cooling actively by applying a gas, a liquid, a mixture of gas and liquid, or a mixture of gas and solid, to the vicinity of said defined region or directly to said defined region.

Without wishing to be bound to any theory, the present inventors assume the cutting is due to thermal gradients along the cutting path. Mechanical tensions occurring when a previously heated region cools down again lead to cracking and cutting, respectively. These thermal gradients may be enhanced, thereby also enhancing the crack causing mechanical tensions, by promoting the cooling of these pre-heated regions. In the most simple case, cooling occurs by simple heat conduction from the pre-heated region into the remaining bulk of the substrate. However, more sophisticated cooling schemes can be used: (1) increasing the heat removal by passive cooling due to attachment of a large heat reservoir to the substrate and (2) active cooling using e.g. heat pumps or using a coolant added to the substrate (e.g. gas or liquid stream). By localizing the application of these cooling aids the separation region inside the substrate may be more accurately defined.

In one embodiment, said method further comprising the step:
a2) cooling said defined region, prior to step b).

In order to improve cutting performance (as measured by cutting speed, cutting accuracy), a pre-cooling step a2) may be employed, having two main effects: (1) the brittleness of the material and therefore its tendency to crack is increased and (2) the maximum thermal gradient that can be achieved can be increased. Again without wishing to be bound by any theory, this is believed to be due to the fact that the maximum T inside the substrate is limited, usually by T<<T_{melting}, because usually no cutting occurs anymore. Starting the process at a lower T therefore allows higher gradients.

In one embodiment, in step a2), said defined region is cooled according to any of the methods i)-iii) as described above.

In one embodiment, said cooling, preferably said active cooling, is moved along the same path on the substrate as said defined region is moved.

In one embodiment, said active cooling is applied via one or more nozzle(s) which is positioned at a fixed distance to said electrode(s), and wherein movement of said cooling on said substrate is achieved by moving
i) said nozzle(s) relative to said substrate,
ii) said substrate relative to said nozzle(s), or
iii) both said nozzle(s) and said substrate relative to each other.

In one embodiment, tensions inside the substrate are either induced or reduced along the path where the cut is intended to be performed, prior to step b). This induction or reduction of tensions along the path may also sometimes herein be referred to as “multiple pass process”.

This multiple pass process allows to introduce a preferential path for cutting, which is in particular important for substrate having already high internal tensions, which may be compensated that way.

In one embodiment, said AC voltage source is a high voltage-high frequency device, capable of generating an AC voltage having an amplitude in the range of from 10 V to 10⁷ V, preferably from 100 V to 10⁶ V, more preferably from 100 V to 10⁵V and a frequency in the range of from 1 kHz to 10 GHz, preferably from 10 kHz to 1 GHz, more preferably from 100 kHz to 100 MHz.

In one embodiment, said high voltage-high frequency device is selected from resonant transformers such as a Tesla transformer, Flyback transformer, high power radiofrequency generator, and high frequency solid state chopper based on semiconductors.

In one embodiment, said high voltage-high frequency device is connected to one or more electrode(s) made of any conductive material preferably with high melting point, low electrical resistivity like noble metals, for example palladium, platinum or gold.

For reliable cutting performance, the electrodes used for voltage application must be stable. High melting T materials resistant to oxidation are preferred. As an example, noble metals like Pt, Pd have such properties.

In one embodiment, said electrode(s) have a length in the range of 1-300 mm, preferably from 2-100 mm, more preferably from 3-50 mm, and a average diameter in the range of 0.1-20 mm, preferably from 0.2-10 mm, more preferably from 0.4-4 mm.

To reduce leakage currents and therefore power loss, electrodes should be as short as possible. On the other hand, longer electrodes provide for better handling and heat separation from the hot area. The actual electrode length and thickness therefore is a compromise that depends largely on the power and frequency used.

In one embodiment, said electrode(s) has a pointed tip with a curvature in the range of 1 μm to 5 mm, preferably from 10 μm to 1 mm, more preferably from 20 μm to 0.5 mm

Without wishing to be bound by any theory, the inventors have observed that having a sharp electrode tip better defines the site where the electric arc originates. This is therefore important for reliable operation.

In one embodiment, said substrate is made from an electrically insulating material, such as glass, e.g. hardened glass, ion treated glass, tempered glass, fused silica, quartz, diamond, alumina, sapphire, aluminium nitride, zirconia, spinel, ceramics, electrically semiconducting materials, such as silicon, including doped silicon and crystalline silicon, germanium, compound semiconductors, such as gallium arsenide and indium phosphide.

In one embodiment, said substrate, on one or both sides, has an additional layer of a conductive material, such as indium tin oxide (ITO), or non-conductive material, such as metal oxide, attached.

In one embodiment, the voltage and power are adjusted according to the electrical and physical properties of the substrate, like relative permittivity, conductivity, coefficient of thermal expansion, thickness.

Without wishing to be bound by any theory, heat dissipation in the substrate is

pᵢₙ=∈ᵣ∈₀ tan δωE²

The increase in temperature is proportional to pin: dT=(pᵢₙ/ρc)dt.

Optimal cutting conditions often require a defined heat entry dT/dt. Therefore, to adapt to (1) material properties (e.g. ∈, tan δ, ρ, c), (2) Speed (inversely proportional to dt) and (3) geometrical parameters (e.g. thickness), it is usually necessary to set the voltage and frequency accordingly. As the voltage drop across the substrate during the process also depends on its T, which by definition of the cutting process is bound to change, using a voltage source of a specific impedance may be necessary.

In one embodiment, a resonant transformer having a transformer driving circuitry is used as AC voltage source and the substrate is part of the closed electrical circuit and affects the resonant frequency of the closed circuit such that the frequency of the transformer driving circuitry is adjusted according to the physical properties of the substrate such as its dimensions and dielectric properties.

Typically a resonant transformer works by driving the secondary transformer coil at or near its resonance frequency. Putting the substrate between the two ends of this secondary coil will change its resonance frequency and therefore the frequency necessary for driving it. The change in resonant frequency depends on the dielectrical and geometrical properties of the substrate and may require corresponding adjustment of the driver for optimal operation.

In one embodiment, a resonant transformer is used as AC voltage source, driven by a fixed frequency which is set to match the resonance of the circuit as described above.

The circuit driving the resonant transformer may be designed in such a way as to pick up the eigenfrequency or resonant frequency of the transformer. This will allow for an auto-tuning of the power source even if e.g. material or geometrical substrate parameters change.

In one embodiment, a resonant transformer is used as AC voltage source, driven with a frequency deviating from the resonance frequency in order to control the properties of the electrical arc as well as the dielectric loss inside the substrate.

Using a fixed frequency of the voltage source can be used if conditions under which cutting occurs are not going to change significantly. It also allows to control the electric arc behaviour as well as focusing and heating of the substrate by frequency selection.

In one embodiment, during step b), substrate material within said defined region is not melted and is not removed or ejected from said defined region.

In one embodiment, during step b), substrate material within said defined region is melted and/or is removed from said defined region.

In one embodiment, said path is a straight line, a curve, an angled line, a closed line or any combination of the foregoing, said path defining where said substrate is cut.

In one embodiment, separation of the substrate, preferably along said path, is controlled by applying a mechanical compressive or tensile force to the substrate.

Without wishing to be bound by any theory, the present inventors believe that cutting occurs by defined introduction of tensions leading to substrate cracking/separation. A superposition of these tensions with other tensions introduced externally provides means for a better control of the cutting path. This can be done, for example, by pressing or pulling the substrate applying force to its borders.

In one embodiment, prior to step b), a first fracture precursor, like a first artificial crack, is introduced into the substrate, and step b) is initiated at said first fracture precursor.

In one embodiment, prior to step b), a second fracture precursor, like a second artificial crack, is introduced into the substrate, and step b) is performed so that the separation path finishes passing upon said second fracture precursor, e.g. second artificial crack.

To provide guidance for the final part of the cut, an artificial fracture pre-cursor can be introduced in the final part of the cut. Such fracture precursor can be obtained e.g. mechanically scratching the substrate using a sharp element harder than the substrate itself.

In one embodiment, movement of said defined region along said path on the substrate surface and movement of said cooling on said substrate occurs at a speed in the range of from 0.01 mm/s to 10000 mm/s.

In one embodiment, the movement of said defined region along said path on the substrate surface is slowed down in an initial and a final part of the separation of the substrate, in order to improve the quality of the separation in such parts

In one embodiment, the power and/or the voltage and/or the frequency are adjusted in order to compensate for the reduced speed in the initial and final part of the cut, for example maintaining a constant speed/power ratio.

Mechanical stress conditions, in particular during cutting, differ between the bulk of the substrate and its rim area. To compensate for these changes during cutting it may be necessary to change speed and cutting power. An example is the ramping up of speed and power in the beginning of the cut and the ramping down of both parameters when approaching the end of the cutting path.

The objects of the present invention are also solved by a device for performing the method according to the present invention, said device comprising:
a) an AC voltage source capable of applying a voltage in the range of from 10 V to 10⁷ V at a frequency in the range of from 1 kHz to 10 GHz,
b) a first electrode connected to said AC voltage source,
c) holding means to hold a substrate to be cut and to expose one side of said substrate to said first electrode,
d) optionally, cooling means arranged at a fixed distance to said electrode, for cooling the substrate,
e) means to move the electrode, optionally in conjunction with the cooling means, if present, and the substrate, relative to each other,
f) control means to control a), d), if present, and e),
g) optionally, a counter-electrode placed on the opposite side of the substrate.
h) optionally, a cooling nozzle placed on the opposite side of the substrate.

It should be noted that a)-c) and e)-f) are mandatory, whereas d), g) and h) are optional and are, independently, present in some embodiments.

In one embodiment, said AC voltage source comprises a frequency generator driving a power stage, a primary coil of a resonant transformer as a Tesla generator connected to said power stage, a secondary coil of said resonant transformer connected to said first electrode, and a feedback mechanism to control/set the power output of the resonant transformer.

In one embodiment, the device according to the present invention further comprises a numerically controlled equipment capable of moving the electrode(s) and/or a substrate held by said holding means, and a supervising camera.

In one embodiment, said control means also control performance of the method as defined above, by said supervising camera and said numerically controlled equipment.

Typically, the substrate to be cut is amenable to separation upon the introduction of thermal gradients to said substrate.

It should be noted that the cut that is achieved by the method according to the present invention may be perpendicular with respect to the surface of the substrate. However, in other embodiments, the cut may also be at an angle which is not 90°, e.g. >90°, such as 95°, 100°, 105° etc., or <90°, such as 80°, 70°, 60°, etc. All these angles which are formed between the side face of the substrate and the top surface or the bottom surface of the substrate are encompassed by the present invention.

The term “ . . . is applied to the vicinity of said defined region”, as used herein, is meant to refer to applying said stream to an area around said defined region, which area is the area affected by the heat provided in step b). In one embodiment, said area has a size in the range of from 0.001 cm² to 100 cm², preferably from 0.1 cm² to 10 cm², more preferably 0.1 cm² to 1 cm². The term, however, is also meant to include an application of said stream to the defined region directly.

The term “vicinity of said defined region”, as used herein, is also meant to refer to and used synonymously with “heat affected area”.

The terms “Tesla transformer” and “Tesla generator”, as used herein, are used interchangeably throughout.

In embodiments in accordance with the present invention, a voltage is applied to the substrate, resulting in a current flow to said substrate, using an electrode connected to an AC voltage source. Typically, the electrical current enters the substrate at a defined point on the substrate, which point is herein also sometimes referred to as “defined region”, meaning the region on the substrate, where said electrical current enters into it. In one embodiment, the electrode, which is used to apply the voltage and the electrical current to the defined region on said substrate, is placed at a distance from the substrate in the range of from 0 mm to 100 mm. If the electrode is placed at 0 mm from the substrate, this means that the electrode is in contact with said substrate. If the electrode is placed, at a distance >0 mm to said substrate, this means that the electrode is not contacting the substrate directly. In order for an electrical current to flow, an electric arc will form. A person skilled in the art will be in a position to determine the parameters necessary to generate electrical arc formation so as to start the flow of an electrical current from the electrode to the substrate at the defined region.

Typically, in embodiments in accordance with the present invention, the application of an electrical current to the substrate will cause a heating of the substrate locally at the defined region. It should be noted that this heating is normally performed such that no melting of material within the defined region of the substrate occurs, and also, no material is removed or ejected from the defined region. A local melting of the substrate is mostly counterproductive in that it would interfere with the cut formation.

In preferred embodiments, the heating that occurs in step b) is achieved by the afore-mentioned application of an electrical current to the substrate, more specifically the application of an electrical current at a frequency in the range of from 1 kHz to 10 GHz. Consequently, in these embodiments, dielectric losses can contribute to the heating of the substrate, increasing the effect carried on by the electric arc.

In accordance with embodiments of the present invention, the defined region on the substrate is moved along the substrate. This means that the site where the voltage is applied and, accordingly, where the current flows to the substrate, the substrate is not stationary but is moved. Such movement is typically achieved by one of the following: (i) a movement of the electrode relative to the substrate, (ii) a movement of the substrate relative to the electrode, or (iii) a movement of both the electrode and the substrate, in relation to each other. Typically, the relative movement occurs along a path on the substrate surface. This path then also decides the shape in which the substrate is cut. Such path, in accordance with the present invention, is not along one of the edges of the substrate, but is across the substrate, either fully or, at least, in parts. Such path may be a straight line, a curved line, an angled line, or it may also be a closed line, the latter for example if a piece of substrate is to be cut out from the interior of the substrate.

In accordance with the present invention, the material in the defined region, although being heated, is usually not melted, let alone removed or ejected from the substrate. Any melting that would occur would interfere with the precision and/or quality of the cut.

In embodiments according to the present invention, step c), i.e. cooling the heated defined region, occurs passively by heat convection and/or conduction away from the entry region. In other embodiments, the cooling occurs largely by active cooling. Such active cooling can be achieved by applying a stream of gas, such as air, nitrogen, argon, or a stream of liquid, such as dichloromethane, chloroform, or a stream of mixtures of gas and liquid, aerosols, or of a mixture of gas and solids, e.g. carbon dioxide dry ice.

Preferably, the cooling is also of a local nature, i.e. the cooling occurs along the same path on the substrate as the path on which the defined region is moved. This can, for example, be achieved by placing the electrode and the cooling means, such as a cooling nozzle, at a fixed distance, relative to each other, and by letting the cooling means trail behind the electrode at such fixed distance. The present inventors, however, also envisage embodiments, wherein the cooling device precedes the electrode along the path. In this embodiment, the defined region would be cooled first and subsequently heated, and the order of steps b) and c) would be effectively reversed, with the defined region first being cooled, and subsequently being heated through the application of an electrical voltage and current to it. There are also embodiments possible in which both a cooling step precedes the heating, and a further cooling step follows the heating. All these scenarios are envisaged by the present inventors and are encompassed by the present invention.

Typically, the electrode with which a voltage and current are applied to the substrate is placed on one side of the substrate. In some embodiments, there may be a second electrode, i.e. a counter-electrode, which is placed on the opposite side of the substrate. Such a second electrode provides a current return path for the first electrode.

The movement of the defined region occurs at a speed in the range of from 0.01 mm/s to 10000 mm/s. As outlined above, such movement is achieved by a relative movement of the electrode to the substrate or vice versa, or a movement of both with respect to each other. Hence, also the relative speed between the electrode and the substrate should be in the range of from 0.01 minis to 10000 mm/s, and the path of said movement can have any curvature radius, ranging from 0 (angles) up to infinite (line), including any possible rounded profile.

Typically, the voltage that is applied is in the range of from 10²V to 10⁷V and has a frequency in the range of from 1 kHz to 10 GHz. The high frequency thus applied causes (1) dielectric losses in side the substrate and (2) a current flow usually manifested by an electric are which, in turn, heat the substrate at the defined region of the substrate.

Without wishing to be bound by any theory, the present inventors believe that the heat that is entering into the substrate induces mechanical tension in the substrate, thus making the path of defined regions amenable to controlled breakage or controlled separation. The effect can be further improved by enhancing the temperature gradients causing the tensions through additional cooling, as described above; such cooling may occur before or after local heating or both.

The controlled breakage and separation may also further be supported by additional mechanical means, such as mechanical stress, induced by suitable means, such as suitable pulling or gripping means or also ultrasonic equipment.

In embodiments in accordance with the present invention, the relative movement of the electrode/the cooling means with respect to the substrate may occur by means of numerically controlled equipment which is locally or remotely operated. The entire setup for performing the method in accordance with the present invention can be controlled using a suitable computer system, such as a personal computer equipped with a suitable input/output interface, or a stand-alone controlling device, connected to a numeric control equipment for the control of the substrate and/or the electrode movements, or a combination of the foregoing. As outlined further above, the means for cooling are preferably moved together with the electrode, in relation to the substrate. This is, for example, achieved by keeping the means for cooling at a fixed distance from the electrode, typically in the range of from 0.1 mm to 100 mm.

Useful high voltage-high frequency devices which are suitable in accordance with the present invention such as Tesla transformers, Flyback transformers, high power radiofrequency generators and high frequency solid state choppers based on semiconductors.

The present invention also envisages a device or performing the method in accordance with the present invention. Such device comprises
a) an AC voltage source capable of applying a voltage in the range of from 10² to 10⁷V at a frequency in the range of from 1 kHz to 10 GHz,
b) a first electrode connected to said AC voltage source,
c) holding means to hold a substrate to be cut and to expose one side of said substrate to said first electrode,
d) optionally cooling means arranged at a fixed distance to said electrode, for cooling the substrate,
e) means to move the electrode, in conjunction with the cooling means, and the substrate, relative to each other,
f) control means to control a), d) and e),
g) optionally, a counter-electrode for placing on the opposite side of the substrate
h) optionally, a cooling nozzle paced on the opposite side of the substrate.

If the cooling nozzle or the counter-electrode is placed on “the opposite side” of the substrate, this is typically with respect to the side where the first electrode is placed.

The inventors have found that by heating a material locally, using electrical energy provided by a high frequency voltage source, thermal tensions can be induced leading to the controlled separation of the material. They further observed that by applying this heating along a predefined path the material may be cut in a defined manner.

In embodiments of the present invention, the local introduction of the electrical and/or thermal power into the substrate may occur by placement of an electrode, connected to a high frequency high voltage source, adjacent to the region to be cut. A defined cut may then be introduced by moving the electrode relatively to the substrate and therefore moving the site where the current enters the substrate. This movement can be obtained either by moving the electrode itself or the substrate with respect to the electrode, or by moving both. The heating occurs mostly by (1) dielectric losses inside the substrate and (2) heat transfer from the electric arc forming between the electrode(s) and the substrate. Due to high frequency phenomena, such as capacitive currents flowing across a nonconductive substrate, the heat may be introduced with one electrode only while the substrate is directly or indirectly connected to ground, or by using another electrode connected directly or indirectly (e.g. via a capacitor) to ground. Said electrode can be placed in such a way that the current flow and therefore the heating within the substrate follow a preferential path determined by the user. In one embodiment, the voltage that is applied has an amplitude in the range of from 10 V to 10⁷ V, preferably from 100 V to 10⁶ V, more preferably from 100 V to 10⁵V. Also in one embodiment, the voltage source is a high frequency voltage generator having a frequency in the range of from 1 kHz to 10 GHz, preferably from 10 kHz to 1 GHz, more preferably from 100 kHz to 100 MHz. In one embodiment, the applied voltage has a frequency in the range of from 1 kHz to 10 GHz, preferably from 10 kHz to 1 GHz, more preferably from 100 kHz to 100 MHz. These parameters can be adjusted so that average currents range from 10⁻⁹ A to 10³ A, more preferably 10⁻⁷ A to 10² A, more preferably 10⁻⁵ to 1 A.

Such high voltages and high frequencies can for example be generated using a Tesla transformer, or any other high frequency—high voltage supply able to match said specifications. Such voltage supply may be tunable in terms of output voltage, frequency, current, impedance. The working distance between the electrode and the substrate affects the geometry of the heating spot, therefore controlling the spatial thermal profile of the heated region of the substrate. In one embodiment, the distance between the electrode and the surface of the substrate is ranging from 0 mm (contact) to 10 cm, preferably from 0 mm to 10 mm, more preferably from 0.05 mm to 5 mm.

Varying the relative speed of the electrode(s) with respect to the surface, it is possible to tune the quantity of thermal and electrical energy entering into the substrate and therefore heating it. The speed at which the electrode and the surface are moved with respect to each other ranges typically from 0.01 mm/s to 10000 mm/s, preferably from 0.1 mm/s to 100 mm/s, more preferably from 1 mm/s to 10 mm/s.

In the method and the device according to the present invention, the electrode in accordance with the present invention may adopt any shape, but has preferably a pointed shape pointing towards the surface of the substrate. Such electrode can be made of various materials; it was found that noble metals with high melting points, e.g. platinum or palladium, work particularly well.

As high frequency—high voltage power supply, a Tesla transformer can be used. The primary coil may consist of up to 100 turns, preferably 1 to 10 turns, more preferably 1 to 2 turns, which can be realized either in planar or helical shape having a diameter ranging from 5 mm to 1000 mm, preferably 10 mm to 100 mm, more preferably from 10 mm to 60 mm. Such turns can be obtained from solid conducting material (e.g. copper, aluminium, noble metals), either in form of wire/tape or in form of deposited layers. The secondary coil can be obtained from a conducting wire with a diameter ranging from 0.01 mm to 10 mm, preferably from 0.05 mm to 5 mm, more preferably from 0.1 mm to 1 mm, and can have a number of turns ranging from 10 to 10⁵ turns, preferably from 50 to 10⁴ turns, more preferably from 60 to 1000 turns. Such secondary winding can be placed in different but usually concentric positions relatively to the primary: above it, inside it or just near to it.

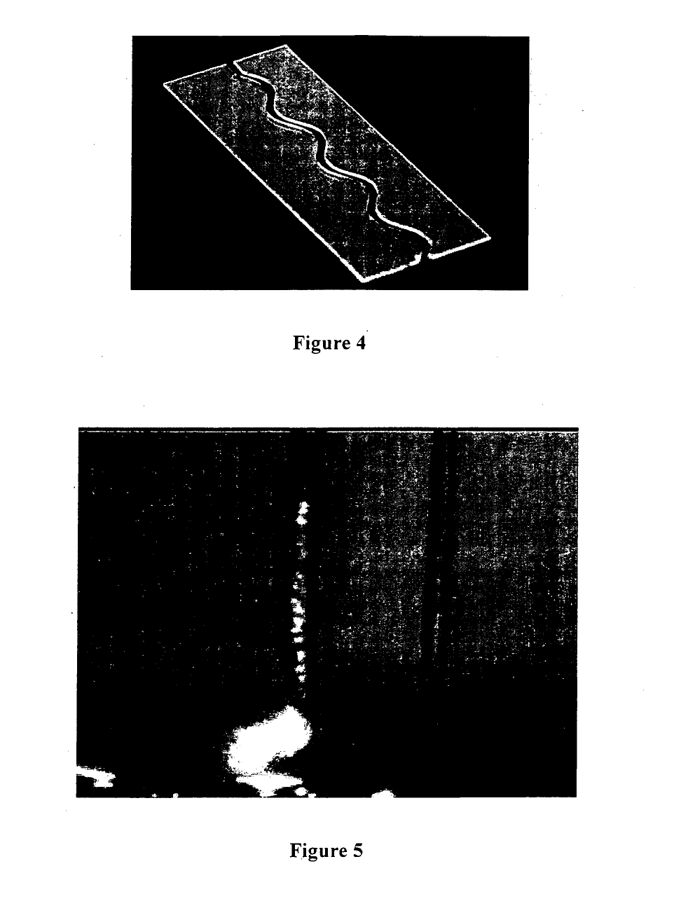

One exemplary setup used consisted of a high frequency Tesla transformer, with a primary coil of 1-2 turns realized in planar shape, using a printed circuit board patterning, with a diameter of ca 20 mm. The secondary winding of 100 to 300 turns was obtained from copper wire with a diameter ranging from 0.1 mm to 0.5 mm, and it was placed inside the primary coil. As electrode, both platinum and palladium were used in the shape of a pointed rod with a diameter of 0.5 mm to 2 mm. The power electronics necessary for driving the primary coil were based on semiconductors, such as for low power applications (up to 50 W) monolithic MOS gate drivers, such as IXDD414 from IXYS, and for high power applications, high frequency high power MOSFETs (e.g. IXZ 2210N50L, DE275×2-102 N06A up to 500 W). The system was operated at 2-20 MHz with a supply voltage for the primary coil of 5V to 30V. Using such parameters, different substrates, e.g. glass substrates, with a thickness ranging from 0.1 mm up to 2 mm were successfully cut (see FIGS. 4, 5, 6a and 6b).

It was also observed that the formation of the thermal tensions and subsequent material separation can be further controlled using an additional cooling device which cools the heated region at a defined time and with a defined magnitude before and/or after heating. Possible embodiments of this improvement include the pre-cooling of the substrate to be cut, cooling by application of gas streams (e.g. air, nitrogen, argon), liquids (e.g. dichloromethane, chloroform), mixtures of gas and liquid (aerosols) or gas and solids (e.g. carbon dioxide dry ice). As an example, for the above mentioned Tesla transformer parameters the additional cooling step was successfully performed using e.g. a nozzle with a diameter of 1 mm spraying air at ˜10° C. with a relative pressure of 1 bar, at a distance of 1 mm from the substrate's surface and placed at a distance of 10 mm with respect to the electrode.

Glass properties such as thickness and thermal expansion coefficient have major impacts in the behavior of the glass during the cutting process; therefore a thicker glass or a glass with a low coefficient of thermal expansion will result on a cutting process needing more current and/or less speed to increase the amount of transferred energy.

The invention can be applied to different homogeneous or heterogeneous materials, including glass (borosilicate, float glass, soda lime and other forms, e.g. also hardened glass, ion treated or plasma treated glass, tempered glass), silica, fused silica, sapphire, special glassy materials (hardened glass, ion-treated or tempered) and layered materials, which tend to plastically break. Also substrates having none-flat or irregular surfaces are amenable to the invented method. However, to improve results under these conditions the setup may be adapted in such a way as to have the electrode(s) follow substrate surface having a defined, e.g. constant, distance to the substrate surface. Typical thicknesses of substrate materials vary in the range from 0.01 mm to 5 mm, preferably from 0.1 mm to 2 mm. In one embodiment, the substrate, on one or both sides, has an additional layer of a conductive material, such as indium tin oxide (ITO) or non-conductive material, such as metal oxide, attached.

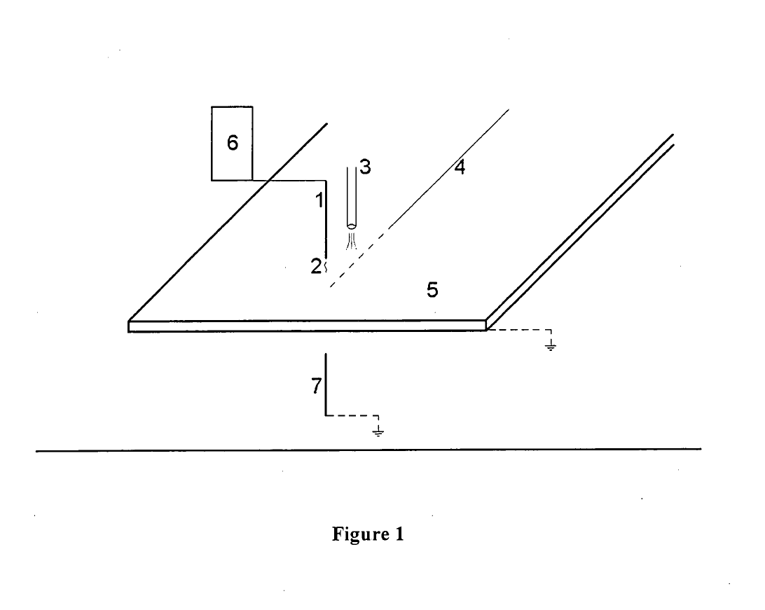

Moving the substrate and electrode(s) along a linear, i.e. single dimensional, path with respect to each other a straight line cut or separation will be produced. Substrates with complex shapes can be obtained applying the invented method while controlling the electrode(s) position/movement in such a way as to follow the requested shape on the substrate. In the tested configuration, complex shapes were easily obtained, including rectangles with rounded edges and undulating line cuts (FIG. 1).

To obtain precisely cut substrates, the relative movement between the electrode and the substrate may be controlled by numerically controlled electromechanical equipment. In a possible configuration, the electrode(s) are moved by the positioning machine over the substrate, or alternatively, the substrate is moved while keeping the electrode(s) in a fixed position; combinations of such two options are also possible. In order to control and adapt the electrical and mechanical parameters in an appropriately short time (typically keeping the corrective intervention time below 100 ms), a feedback loop can be implemented. In this way, basing on measured values of currents, voltages and/or temperatures, it is possible to adjust voltage generator parameters, cooling system, substrate-electrode(s) distance and/or speed in real time to maintain a regular process.

Such setups can be controlled and driven by means of a suitable computer system such as a PC equipped with a suitable input/output interface or a stand-alone controlling device, connected to the numeric control equipment for the control of the substrate and/or the electrode movements or a combination thereof.

Since the initiation of the cutting process may be a critical event, a seeding crack (or artificial irregularity) can be introduced to make the process more precise by determining the correct initiation site of the cut. Such irregularities can be placed either on the edge of the substrate, in case of cuts starting from the border of the material, or within the substrate itself. Such seeding cracks inside the substrate are important in case of closed cuts inside the substrate, i.e. not crossing the outer border. Multiple irregularities placed in the sample can be useful to predefine complex separation paths.

Moreover, reference is made to the following figures, which are given as exemplary embodiments.

More specifically,

FIG. 1 shows an exemplary embodiment of an electrode (1) pointed to the surface of the material (5). Such electrode (1) is connected to a generator (6) which may or may not be grounded. Upon voltage application/generation by the generator (6), an electric arc (2) forms between the surface of the material and the electrode. A cooling system (3) is placed at a fixed distance from the electrode blowing a cooling medium which may be in gaseous, liquid or aerosol form. The electrode (followed by the cooling nozzle) and the surface of the material are moved in relation to each other in the direction of the cut to be obtained (4), to expose the surface to be cut to the electrode. An optional counter-electrode (7) could follow in the opposite side of the substrate to be cut. The dotted line indicates the region in which the cut is expected to occur.

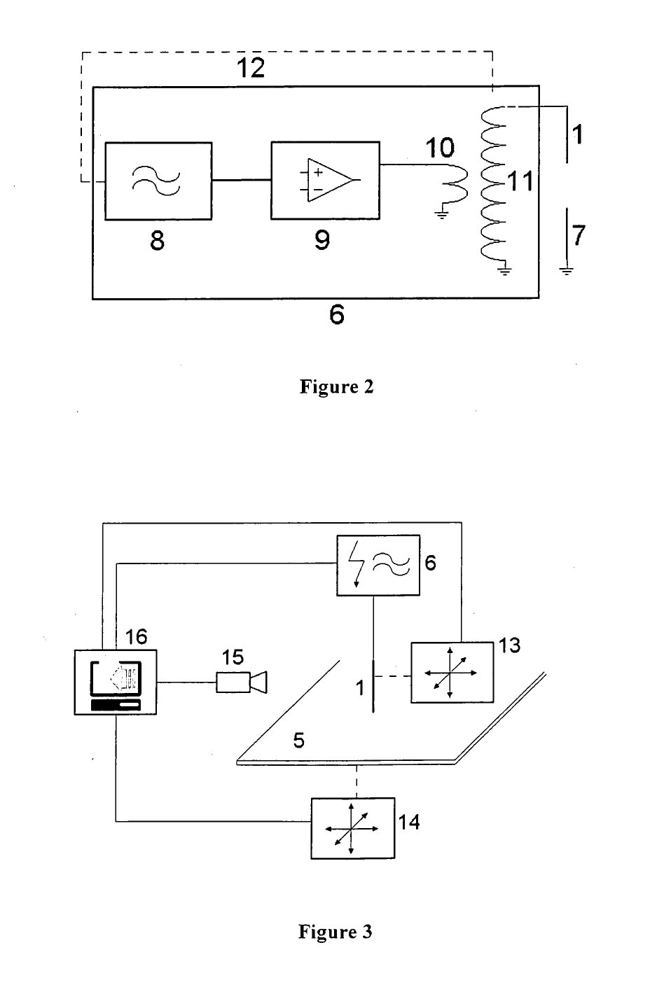

FIG. 2 shows the possible embodiment for the electrical part of the invented device: (8) High frequency generator driving a power stage (9) connected to the primary coil (10) of a Tesla generator. The secondary coil (11) is connected to the electrode (1) that will be placed close to the substrate, possibly with a grounded counter electrode (7). An optional feedback (12) tunes the frequency produced by the generator.

FIG. 3 shows a possible arrangement for the automation of the invented device, including the substrate (5), the electrode (1) connected to the voltage supply (6), a numerically controlled equipment moving the electrode (13) or the substrate (14), a supervising/feedback camera, operating in the visible, infrared or ultraviolet range (15), a controlling device (16).

FIG. 4 shows a microscope slide made of D263T glass (thickness: 0.7 mm): 2.5 A, 3.85 mm/s, 1 bar cold air, 500 um sample-electrode distance.

FIG. 5 shows that an electric arc forms between the glass sample and the electrode during the cutting process. The nozzle blowing cold air is following the electrode one cm behind to control the temperature profile and avoid random cracks to start.

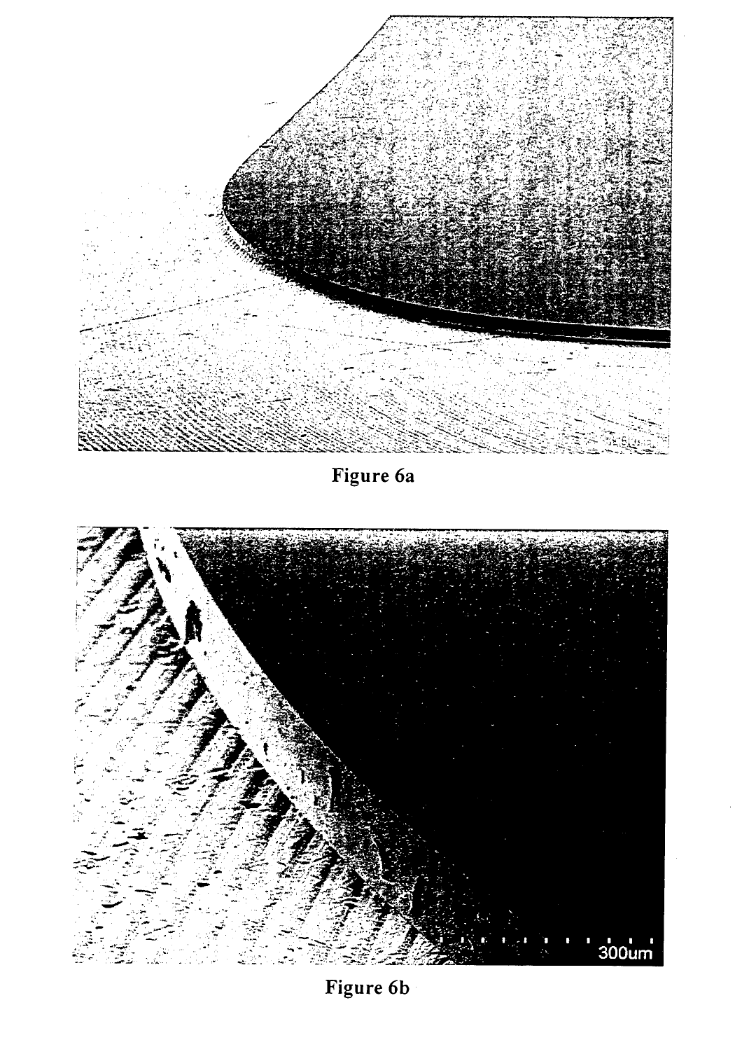

FIGS. 6a and 6b show hardened glass (thickness: 0.7 mm): 2.5 A, 3.85 mm/s, 1 bar cold air, 500 um sample-electrode distance.

Moreover, reference is made to the following examples which are given to illustrate, not to limit the present invention.

### EXAMPLES

### Example 1

In order to cut a D263T glass microscope slide in a waved shape, the path followed by the electrode and the air nozzle was programmed using a code language. An interface between a computer and a numerically controlled electromechanical equipment was used to transmit the path that the electrode and the air nozzle had to follow. The microscope slide glass thickness being 0.7 mm, the parameters applied to obtain a the cut were; 2.5 A current with a speed of the electrode and air nozzle of 3.85 mm/s, 1 bar pressure of cold air going out from the nozzle and a distance between the electrode and the glass sample of 0.5 mm. The resulting cut obtained can be seen in FIG. 4.

### Example 2

In order to cut hardened glass, the path followed by the electrode and the air nozzle was programmed using a code language. An interface between a computer and a numerically controlled electromechanical equipment was used to transmit the path that the electrode and the air nozzle had to follow.

The hardened glass thickness being 0.7 mm, the parameters applied to obtain a cut were: 2.5 A current with a speed of the electrode and air nozzle of 3.85 mm/s, 1 bar pressure of cold air going out from the nozzle and a distance between the electrode and the glass sample of 0.5 mm. The resulting cut obtained can be inspected in FIGS. 6a and 6b.

The features of the present invention disclosed in the specification, the claims and/or in the accompanying drawings, may, both separately and in any combination thereof, be material for realizing the invention in various forms thereof.

1. A method of cutting a substrate, the method comprising:
applying an AC voltage and an electrical current to a defined region of the substrate via an electrode connected to an AC voltage source, thereby heating the defined region, and
cooling the defined region,
wherein applying the AC voltage and electrical current comprises moving the defined region along a path on a surface of the substrate, by moving the electrode relative to the substrate, moving the substrate relative to the electrode, or both,
the path is not along an edge of said substrate, but transverses the substrate either fully or partially, and
a frequency of the AC voltage is from 1 kHz to 10 GHz.

2. The method of claim 1,
wherein the substrate serves as a counterelectrode, thereby closing an electrical circuit.

3. The method of claim 1, further comprising:
placing a counterelectrode on an opposite side of the substrate, thereby closing an electrical circuit.

4. The method of claim 1, further comprising:
closing an electrical circuit with a counterelectrode,
wherein the counterelectrode is grounded.

5. The method of claim 1,
wherein applying the AC voltage and the electrical current comprises forming an electrical arc between the electrode and the defined region, whereby the electrical arc cuts the substrate.

6. The method of claim 1,
wherein applying the AC voltage and the electrical current comprises adjusting frequency, amplitude, or both of the AC voltage, of the electrical current, or of both; adjusting a distance between the electrode and the substrate; or a combination thereof.

7. The method of claim 1,
wherein a distance from the electrode to a side of the substrate during applying the AC voltage and the electrical current is from 0 mm to 100 mm.

8. The method of claim 1,
wherein applying the AC voltage and the electrical current comprises applying a voltage having an amplitude of from 10 V to 10⁷ V and a frequency of from 1 kHz to 10 GHz.

9. The method of claim 1,
wherein applying the AC voltage and the electrical current comprises controlling properties of an electrical arc by changing an atmosphere surrounding the electrode and the substrate.

10. The method of claim 1,
wherein cooling the defined region comprises:
cooling passively through heat conduction, convection, or both, with surrounding environment;
attaching the substrate to an element able to absorb heat efficiently, optionally working as an active heat pump;
cooling actively by applying a gas, a liquid, a mixture of gas and liquid, or a mixture of gas and solid, to a vicinity of the defined region;
or a combination thereof.

11. The method of claim 1, further comprising:
cooling the defined region, prior to applying the AC voltage and the electrical current.

12. The method of claim 11,
wherein cooling the defined region prior to applying the AC voltage and the electrical current comprises:
cooling passively through heat conduction, convection, or both, with surrounding environment;
attaching the substrate to an element able to absorb heat efficiently, optionally working as an active heat pump;
cooling actively by applying a gas, a liquid, a mixture of gas and liquid, or a mixture of gas and solid, to a vicinity of the defined region;
or a combination thereof.

13. The method of claim 1,
wherein cooling the defined region comprises cooling along the path on the surface of the substrate.

14. The method of claim 1, wherein cooling the defined region comprises:
positioning a nozzle at a fixed distance from the electrode and
moving the nozzle relative to the substrate, the substrate relative to the nozzle, or both.

15. The method of claim 1, further comprising:
inducing or reducing a tension inside the substrate along the path, prior to applying the AC voltage and the electrical current.

16. The method of claim 1,
wherein the AC voltage source is a high voltage-high frequency device configured to generate an AC voltage having an amplitude of from 10 V to 10⁷ V and a frequency of from 1 kHz to 10 GHz.

17. The method of claim 16,
wherein the high voltage-high frequency device is a resonant transformer, a Flyback transformer, a high power radiofrequency generator, or a high frequency solid state chopper based on a semiconductor.

18. The method of claim 16,
wherein the high voltage-high frequency device is connected to an electrode comprising a conductive material.

19. The method of claim 18,
wherein the electrode has a length of from 1 to 300 mm and an average diameter of from 0.1 to 20 mm.

20. The method of claim 18,
wherein the electrode comprises a pointed tip with a curvature of from 1 μm to 5 mm.

21. The method of claim 1,
wherein the substrate comprises an electrically insulating material, or an electrically semiconducting material.

22. The method of claim 21,
wherein an additional layer of a conductive material or a non-conductive material is attached to a side of the substrate.

23. The method of claim 1, further comprising:
adjusting voltage and power according to electrical and physical properties of the substrate.

24. The method of claim 1, further comprising:
closing an electrical circuit, to obtain a closed electrical circuit, and
adjusting a frequency of a transformer driving circuitry according to a physical property of the substrate,
wherein the AC voltage source comprises a resonant transformer comprising the transformer driving circuitry,
the closed electrical circuit comprises the substrate, and
the substrate affects a resonant frequency of the closed electrical circuit.

25. The method of claim 24,
wherein a fixed frequency drives the resonant transformer, and
the fixed frequency matches the resonant frequency of the closed electrical circuit.

26. The method of claim 1,
wherein the AC voltage source comprises a resonant transformer,
a frequency driving the resonant transformer deviates from the resonant frequency, thereby controlling a property of an electrical arc and a dielectric loss inside the substrate.

27. The method of claim 1,
wherein applying the AC voltage and the electrical current does not comprise melting substrate material within the defined region, nor does it comprise removing or ejecting substrate material from the defined region.

28. The method of claim 1,
wherein applying the AC voltage and the electrical current comprises melting substrate material within the defined region, removing substrate material from the defined region, or both.

29. The method of claim 1,
wherein the path is a straight line, a curve, an angled line, a closed line, or a combination thereof, and
cutting the substrate is along the path.

30. The method of claim 1, further comprising:
controlling a separation of the substrate by applying a mechanical compressive or tensile force to the substrate.

31. The method of claim 1, further comprising:
introducing a first fracture precursor into the substrate prior to applying the AC voltage and the electrical current,
wherein the path starts at the first fracture precursor.

32. The method of claim 31, further comprising:
introducing a second fracture precursor into the substrate,
wherein the path finishes at the second fracture precursor.

33. The method of claim 1,
wherein a speed of moving the defined region along the path, and a speed of moving the cooling, are each from 0.01 mm/s to 10000 mm/s.

34. The method of claim 1,
wherein applying the AC voltage and the electrical current comprises slowing the movement of the defined region along the path in an initial part and in a final part of the path, thereby improving a quality of separation in initial part and in the final part.

35. The method of claim 34,
wherein applying the AC voltage and the electrical current further comprises adjusting a power, a voltage, a frequency, or a combination thereof, thereby compensating for slowed speed in the initial part and in the final part.

36. A device for performing the method of claim 1, the device comprising:
an AC voltage source configured to apply a voltage of from 10 V to 10⁷ V at a frequency of from 1 kHz to 10 GHz,
a first electrode connected to the AC voltage source,
optionally, a counterelectrode on an opposite side of the substrate, and
optionally, a cooling nozzle on an opposite side of the substrate,
wherein the device is configured to hold the substrate, to expose one side of the substrate to the first electrode, to move the electrode and the substrate relative to each other, and to control the AC voltage source,
the device is optionally further configured to cool the defined region with a cooling device at a fixed distance from the electrode, and
the device is optionally further configured to control movement of the electrode in conjunction with the cooling device, if present.

37. The device of claim 36,
wherein the AC voltage source comprises a frequency generator, a primary coil of a resonant transformer as a Tesla generator, a secondary coil of the resonant transformer, and a feedback mechanism,
the frequency generator is configured to drive a power stage,
the primary coil is connected to the power stage,
the secondary coil is connected to the first electrode, and
the feedback mechanism is configured to control, set, or both control and set a power output of the resonant transformer.

38. The device of claim 36, further comprising:
a supervising camera, and
a numerically controlled equipment configured to move the electrode, the substrate, or both.

39. The device of claim 38,
wherein the device is further configured to control the method with the supervising camera and the numerically controlled equipment.
